(19) United States
(12) Patent Application Publication
(10) Pub. No.: US 2005/0058468 A1
(43) Pub. Date: Mar. 17, 2005

(54) Monitoring of receiver type usage in a printing machine

(76) Inventor: Timothy W. Reynolds, Rochester, NY (US)

Correspondence Address: PATENT LEGAL STAFF;EASTMAN KODAK COMPANY, 343 STATE STREET, ROCHESTER, NY, 14650-2201, US

(21) Appl. No.: 10/938,769

(22) Filed: Sep. 10, 2004

Related U.S. Application Data
(60) Provisional application No. 60/503,656, filed on Sep. 17, 2003.

(51) Int. Cl. G03G 21/02

(52) U.S. Cl. 399/79

(57) ABSTRACT

An electrographic printing machine (10) including multiple print counters (23; 26) is disclosed. The printing machine (10) is capable of printing images on various receiver sheet types, including transparencies, label stock, and of course paper of various composition, finish, size, and color. A main print counter (23) keeps a count of each sheet printed by the printing machine (10), regardless of receiver sheet type. Receiver sheet type counters (26) are each associated with a receiver sheet type, and maintain counts of sheets printed by receiver sheet type. The contents of type counters 26 can be used in the calculation of printing charges, maintenance intervals, and the like, considering that machine wear, contamination, and use of consumables varies for various receiver sheet types.

### CROSS-REFERENCE TO RELATED APPLICATIONS

This application claims the priority date of U.S. Provisional Application Ser. No. 60/503,656 filed Sep. 17, 2003 entitled “MONITORING OF RECEIVER TYPE USAGE IN A PRINTING MACHINE”.

### STATEMENT REGARDING FEDERALLY SPONSORED RESEARCH OR DEVELOPMENT

Not applicable.

### BACKGROUND OF THE INVENTION

This invention is in the field of digital printing, and is more specifically directed to the management of high volume electrophotographic printing machines.

Electrographic printing has become a prevalent technology in the modern computer-driven printing of text and images, on a wide variety of hard copy media. This technology is also referred to as electrographic marking, electrostatographic printing or marking, and electrophotographic printing or marking. Conventional electrographic printers are well suited for high resolution and high speed printing, with resolutions of 600 dpi (dots per inch) and higher becoming available even at modest prices. At these resolutions, modem electrographic printers and copiers are well-suited to be digitally controlled and driven, and are thus highly compatible with computer graphics and imaging. Examples of conventional printing machines with this capability include the DIGIMASTER 9110 network imaging system and the DIGIMASTER 9150i digital press, both available from Heidelberg USA, Inc. These modern conventional printing machines are capable of printing images on a wide range of types of receiver sheets, or media types, examples of which include paper of various sizes, finishes, and composition, label stock, transparencies, and the like.

Modern electrophotographic printing machines operate at extremely high volumes, yet are required to print documents at very high resolutions and precision, necessitating extremely tight mechanical tolerances. It is known that the printing of each receiver sheet will effect some amount of wear on various mechanical components of the printing machine, such as rollers that handle the receiver sheets at the transfer station (at which toner is transferred from a photoconductor to a receiver sheet) and at the fuser station (at which toner is fused to the receiver sheet). Several components in the image loop are also subject to wear as each sheet is printed. This wear is, of course, a factor in the usable life of serviceable parts in the printing machine, in order to maintain the mechanical tolerances required for high-precision high-speed printing. It is known that these wear effects can vary with the type of receiver sheet being printed.

In addition to wear effects, each receiver sheet that is printed also contributes to contamination of the printing machine. This contamination includes dust and particles from the receiver sheets themselves, as well as toner residue, release oils, and other materials involved in the printing of each sheet. Periodic maintenance is required to remove the contamination resulting from the printing process. It is known that the contamination generated by each printed sheet will also vary among the various receiver sheet types.

In addition to wear and contamination, it is known that the rate at which the printing machine consumes materials such as toner, release oil, and the like, varies with the type of receiver sheets printed.

By way of further background, conventional printing machines typically include a meter, or counter, which counts the number of images printed by the printing machine. Conventional service contracts and maintenance schedules are based on this meter count. Indeed, the price charged by a service provider for maintenance of a printing machine is often based on a metered count of images printed, with higher meter counts resulting in a higher service contract price over time. In conventional printing machines, this count is simply a count of printed images (typically by counting receiver sheet feeds), without regard to the paper type or receiver type that was actually used. The pricing of a service contract is typically based on an expected service cost over a number of images, and assuming a standard mix of receiver sheet types.

As mentioned above, however, the actual usage of receiver sheet types typically varies from the assumed average mix upon which the service contract and maintenance schedule is based. This variation in receiver sheet usage will result in varying wear of printing machine components, in varying contamination, and in varying usage of consumables, for the reasons mentioned above. If the receiver sheet types actually used cause more severe wear, contamination, or consumable use, than the model mix, a higher level of maintenance and component replacement than that upon which the service contract is based will be required. This can result in economic loss for the service provider, or for the printing machine owner in the case of a user-serviced installation.

### BRIEF SUMMARY OF THE INVENTION

It is therefore an object of this invention to provide a printing machine and method of operating the same in which the effects of different receiver sheet types on machine reliability and consumable use can be monitored.

It is a further object of this invention to provide such a machine and method in which servicing of the printing machine can be adjusted according to mix of receiver sheet types actually used.

Other objects and advantages of this invention will be apparent to those of ordinary skill in the art having reference to the following specification together with its drawings.

The present invention may be implemented into an electrographic printing machine by including a service application, or “applet”, that enables a meter or counter that is associated with a plurality of available receiver sheet types. During the printing operations, each type counters counts sheet feeds, or printed sheets, for its associated receiver sheet type. A printer billing application accesses the counts for each receiver sheet type, and calculates such parameters as a billing rate, service schedule, or the like according to these counts.

### BRIEF DESCRIPTION OF THE SEVERAL VIEWS OF THE DRAWING

FIG. 1 is a schematic diagram, in block form, of a printing machine constructed according to the preferred embodiment of the invention.

FIG. 2 is a schematic diagram illustrating a displayed paper catalog as used in the printing machine of FIG. 1 according to the preferred embodiment of the invention.

FIG. 3 is a flow diagram illustrating the operation of a service applet for counting sheet feeds by receiver sheet type, as executed at the printing machine of FIG. 1 according to the preferred embodiment of the invention.

FIG. 4 is a flow diagram illustrating the operation of the printing machine in maintaining sheet feed meter counts in a printing operation, according to the preferred embodiment of the invention.

FIG. 5 is a flow diagram illustrating a service organization account calculation program using the sheet feed meter counts by receiver sheet type, according to the preferred embodiment of the invention.

### DETAILED DESCRIPTION OF THE INVENTION

The present invention will be described in connection with its preferred embodiment, namely as implemented into an electrographic printing machine, as it is believed that this invention will be especially beneficial in such an application. However, it is also contemplated that this invention may also provide similar important benefits in other implementations than an electrographic printing machine as described. Accordingly, it is to be understood that the following description is provided by way of example only, and is not intended to limit the true scope of this invention as claimed.

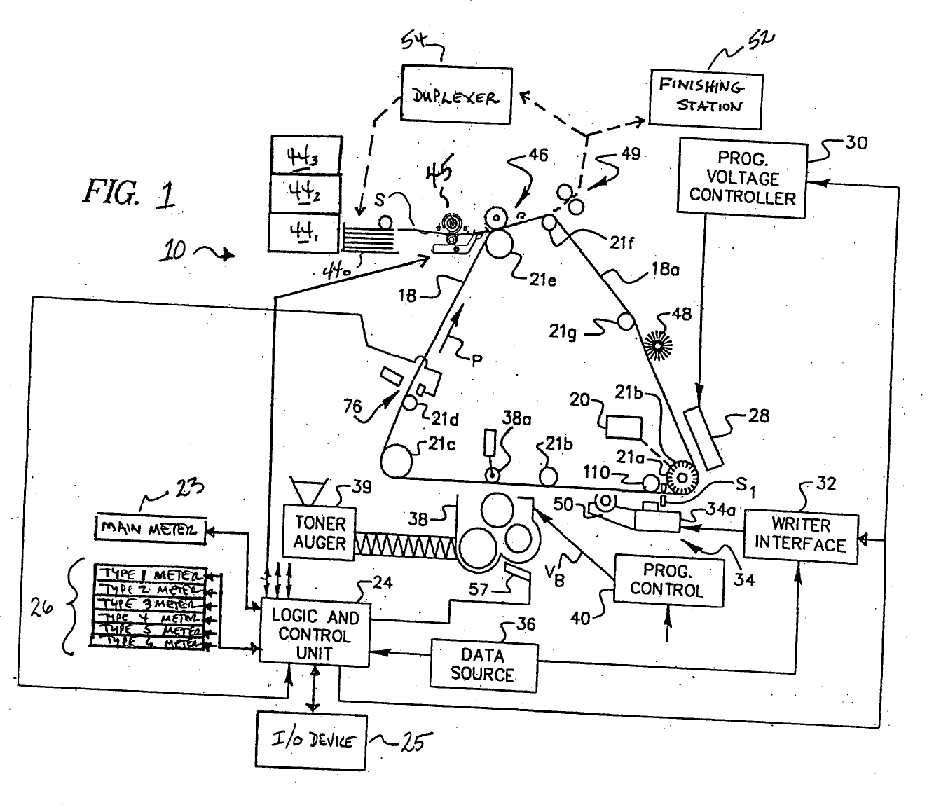

Referring now to FIG. 1, printing machine 10 according to the preferred embodiment of the invention will now be described. In electrographic printing machine 10 of FIG. 1, photoconductor 18, which is a moving recording member such as a photoconductive film belt, is entrained about a plurality of rollers or other supports 21a through 21g, one or more of which is driven by a motor to advance photoconductor 18. In this example, roller 21a is driven by motor 20 to advance photoconductor 18 at a high speed, such as 20 inches per second or higher, in the direction indicated by arrow P, past a series of workstations of the printing machine 10. Alternatively, photoconductor 18 may be wrapped and secured about only a single drum. Still further in the alternative, photoconductor 18 may be implemented by way of a drum having a photoconductive surface.

Printing machine 10 includes logic and control unit (LCU) 24, preferably a digital computer or microprocessor operating according to a stored program for sequentially actuating the workstations within printing machine 10, for effecting overall control of printing machine 10 and its various subsystems. LCU 24 also is programmed to provide closed-loop process control of printing machine 10 in response to signals from various sensors and encoders, in the conventional manner. In this manner, LCU 24 provides overall control of the apparatus and its various subsystems as is well known. LCU 24 will typically include temporary data storage memory, a central processing unit, a timing and cycle control unit, and stored program control. Data input and output is performed sequentially through or under program control. Input data can be applied through input signal buffers to an input data processor, or through an interrupt signal processor, and include input signals from various switches, sensors, and analog-to-digital converters internal to printing machine 10. In addition, LCU 24 is connected to input/output device 25, by way of which control instructions may be received from a human user, and by way of which output signals may be communicated from LCU 24 to the human user. Input/output device 25 may be implemented as a single component, such as a touch-screen as used in conventional printing machines, or alternatively may be implemented by a combination of multiple devices, such as a keypad and display screen. Further in the alternative, input/output device 25 may include a network interface card (NIC) by way of which LCU 24 and printing machine 10 communicates over a computer network to a computer or workstation. For control of printing machine 10, output data and control signals from LCU 24 are applied directly or through storage latches to suitable output drivers and in turn to the appropriate subsystems within printing machine 10.

It will be understood by those skilled in the art having reference to this specification that LCU 24 may refer to a single programmable logic device, function, or subsystem, or alternatively refers, cumulatively, to multiple computing resources that may be distributed throughout printing machine 10. According to this invention, the specific architecture by way of which LCU 24 is realized within printing machine 10 is not particularly important, so long as the functions described herein are carried out. It is contemplated that modern programmable logic devices and systems have sufficient computational capacity to carry out the preferred embodiment of this invention, and that those skilled in the art having reference to this specification will be readily able, without undue experimentation, to generate the appropriate computer programs, and custom hardware, if desired, for implementing this invention as appropriate for their particular needs and applications.

Referring back to the print loop of printing machine 10, primary charging station 28 sensitizes photoconductor 18 by applying a uniform electrostatic corona charge, from high-voltage charging wires at a predetermined primary voltage to surface 18a of photoconductor 18. Other forms of chargers, including brush or roller chargers, may also be used. This operation prepares a portion of photoconductor 18 for receipt of image information, which in this case is applied by exposure station 34 selectively discharging of locations of photoconductor 18.

At exposure station 34, writer 34a projects light in a selected pattern to photoconductor 18. This light selectively dissipates the electrostatic charge on photoconductor 18 to form a latent electrostatic image of the document to be copied or printed. Writer 34a is preferably constructed as an array of light emitting diodes (LEDs), or alternatively as another light source such as a laser or spatial light modulator. In any case, writer 34a exposes individual picture elements (pixels) of photoconductor 18 with light at a regulated intensity and exposure. According to this embodiment of the invention, image data to be printed is provided to writer 34a by data source 36 via writer interface 32. Data source 36 is contemplated to be a computer or microcontroller, itself storing a bit map for the image in its own memory or receiving the bit map over a data network. The pattern of the image to be formed is applied to writer interface 32, along with control signals from LCU 24 that indicate the position of photoconductor 18 at which this image is to be formed.

After exposure, the portion of photoconductor 18 bearing the latent charge image travels to development station 38. As conventional in the art, in this example, development station 38 includes a magnetic brush in juxtaposition to, but spaced from, the travel path of photoconductor 18. Alternatively, other known types of development stations or devices may be used, or plural development stations 38 may be provided for developing images in plural colors, or using toners having different physical characteristics.

Upon the imaged portion of photoconductor 18 reaching development station 38, LCU 24 selectively activates development station 38 to apply toner to photoconductor 18. Preferably, this activation is effected by LCU 24 controlling a mechanism to move backup roller 38a, and thus photoconductor 18, into engagement with or close proximity to the magnetic brush. Alternatively, the magnetic brush may be moved toward photoconductor 18 to selectively engage photoconductor 18. In either case, charged toner particles on the magnetic brush are selectively attracted to the latent image patterns present on photoconductor 18, developing those image patterns. As known in the art, conductor portions of development station 38, such as conductive applicator cylinders, are biased to act as electrodes. Examples of the developer mix used at development station include a two-component mix having a dry mixture of toner and carrier particles; alternatively, a single component developer or a conventional liquid toner may be used. Toner is supplied to development station 38 by motor-driven toner auger 39, under the control of LCU 24.

Registration station 45 and transfer station 46 in printing machine 10 move receiver sheet S into engagement with photoconductor 18, in registration with a developed image in a frame of photoconductor 18, to transfer the developed image to receiver sheet S. Receiver sheets S may be plain or coated paper, label stock, plastic, transparency material, or another medium capable of being printed upon by printing machine 10. In printing machine 10, as is conventional for large scale printers in the art, multiple paper sources 44₀ through 44₃ are provided, from a selected one of which a receiver sheet S is drawn into registration station 45, under the control of LCU 24. Registration station 45 controls the positioning of receiver sheets S at transfer station 46, so that each receiver sheet S reaches transfer station 46 in registration with a corresponding developed image on photoconductor 18. This registration includes registration in the in-track and cross-track directions, and also includes the correction of skew of the receiver sheets S relative to the desired path of travel. An example of the construction and operation of registration station 45, as suitable for use in connection with printing machine 10 according to the preferred embodiment of the invention, is described in U.S. Pat. No. 5,322,273, incorporated herein by this reference.

Transfer station 46 typically includes a charging device for electrostatically biasing movement of the toner particles from photoconductor 18 to receiver sheet S. In this example, the biasing device is roller 46b, which engages the back of sheet S and which is connected to programmable voltage controller 46a that operates in a constant current mode during transfer. Alternatively, an intermediate member may have the image transferred to it, and the image may then be transferred from this intermediate member to receiver sheet S.

Cleaning station 48, such as a brush, blade, or web as is well known, is also located behind transfer station 46, and removes residual toner from photoconductor 18. A pre-clean charger (not shown) may be located before or at cleaning station 48 to assist in this cleaning. After cleaning, this portion of photoconductor 18 is then ready for recharging and re-exposure. Of course, other portions of photoconductor 18 are simultaneously located at the various workstations of printing machine 10, so that the printing process is carried out in a substantially continuous manner.

After leaving transfer station 46, receiver sheet S is detacked from photoconductor 18. At this point, receiver sheet S is carrying a pattern of toner corresponding to the image to be printed as defined by the charge pattern written at exposure station 34. This toner is not yet fused to receiver sheet S at this point, but electrostatically adheres to receiver sheet S. Receiver sheet S then travels to fusing station (fuser) 49 where the image is fixed to sheet S. After fusing at fuser 49, receiver sheet S then passes to finishing station 52 for collating, sorting, stapling, or the like, or alternatively passes to duplexer 54 if the opposite side of receiver sheet S is also to be printed.

Meanwhile, other regions of photoconductor 18 will typically have been exposed and developed with corresponding images, for subsequent pages to be printed. Photoconductor 18 will continue to circulate around the image loop, effecting the printing of additional receiver sheets S in sequence, to continue and complete the printing job.

As shown in FIG. 1, printing machine 10 includes main print meter 23, which is in bidirectional communication with LCU 24. Main print meter 23 is incremented by LCU 24 for each sheet that is printed by printing machine 10. The incrementing is preferably responsive to a somewhat downstream event, such as feeding of a receiver sheet S to registration station 45, to reflect a true count of printed sheets (and avoiding miscounts for those instances in which a paper source is empty). Main print meter 23 is also readable by LCU 24, for example in connection with service software, as will be described in further detail below.

According to the preferred embodiment of the invention, printing machine 10 is capable of printing images and text upon a wide range of types of receiver sheets S, including paper of different weights, finishes, and sizes, label stock of various types, transparencies, pre-printed media, and others. Similarly as in conventional printing machines, such as the DIGIMASTER 9110 available from Heidelberg U.S.A., Inc., multiple paper sources 44 are provided in printing machine 10, each providing a reservoir from which receiver sheets can be drawn into registration station 45. Each paper source 44 may store a separate type of receiver sheet, or multiple paper sources 44 may source the same receiver sheet type. According to the preferred embodiment of the invention, the selection of the particular receiver sheet type to be used in a given print job, and control of printing machine 10 to use the desired receiver sheet type, is effected by LCU 24 in response to user input via input/output device 25, or in response to commands or instructions communicated over a computer network.

According to the preferred embodiment of the invention, LCU 24 and printing machine 10 maintain a paper catalog, identifying each of the receiver sheet types that printing machine 10 can print upon, and identifying the receiver sheet types currently present within printing machine 10. Examples of conventional printing machines, and of paper catalogs as implemented in those machines, are described in United States Patent Application Publication Nos. US 2003/0044194A1 and US 2003/0151651A1, both assigned to Heidelberg Digital, L.L.C. and incorporated herein by this reference. Typically, the paper catalog is a list of entries, each entry corresponding to a type physical stock of receiver sheet that printing machine 10 can utilize. The entry for a selected media in the paper catalog preferably includes an identifier for the media, such as a paper name, and the attributes of that media type. The paper catalog may include some receiver sheet types that are standard over all printing machines, and may also include some user-defined receiver sheet types. The paper catalog thus permits printing machine 10 to store attributes (e.g., size, color, weight, finish, available mode) of each receiver sheet type, so that these attributes need not be entered each time that paper type is selected for printing.

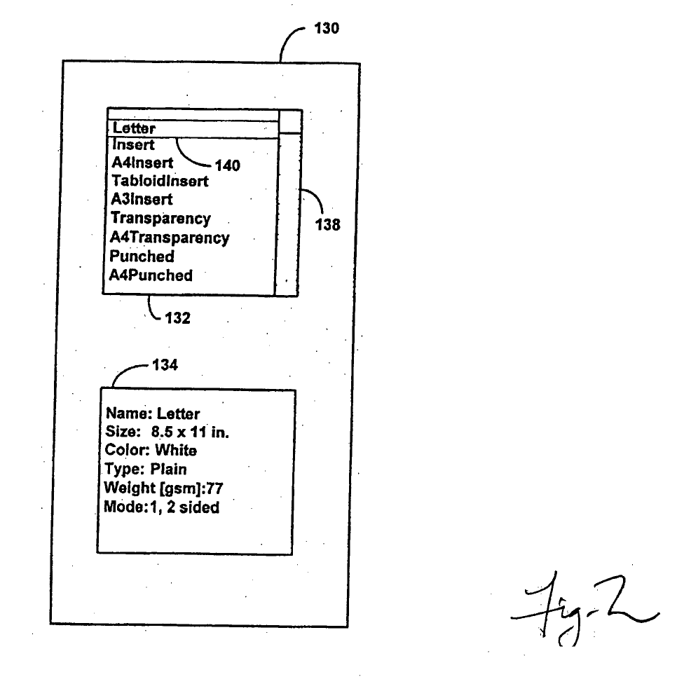

FIG. 2 illustrates an example of a paper catalog, as implemented in printing machine 10 according to the preferred embodiment of the invention, and as may be displayed by input/output device 25 by way of a user interface program or applet. FIG. 2 shows paper catalog screen 130 associated with utility software executed by LCU 24 for showing a paper catalog. In this embodiment of the invention, paper catalog screen 130 includes text window 132, which displays a selection of names of the receiver sheet types stored in the paper catalog, in this example including several sizes of standard paper stock, transparency stock of different sizes, glossy tabloid stock inserts, punched papers, and the like. In this example, text window 132 includes scroll bar 138 by way of which the user navigates through the list of receiver sheet type names in the paper catalog, using a keyboard, keypad, pointing device, or touch screen capabilities of input/output device 25 via the utility software. Selection of an entry in the paper catalog may be made by scrolling with scroll bar 138 until the desired receiver sheet type is displayed in text window 132 and by then selecting the entry by a keystroke or operation of the pointing device, such as a single click of a mouse. The selected entry then preferably appears as highlighted entry 140 on input/output device 25, with text box 134 displaying the attributes of the highlighted media entry 140. In this example, the attributes include the receiver sheet name (e.g., “Letter”), sheet size, color, paper type and weight, and mode parameters relating to whether the receiver sheet can be printed on only one or on both sides.

It should be understood that displaying the paper catalog in text windows 132, 134 is illustrative only, and that the present invention is not restricted to the embodiment illustrated in FIG. 2. For example, input/output device 25 may display the paper catalog as a collection of icons, each corresponding to a receiver sheet type in the paper catalog. The icons may be grouped in an expandable tree and root configuration or independently selectable from a scrollable window, in the familiar manner. Further in the alternative, input/output device 25 may present the paper catalog to the user as a pull-down menu that includes the names of all receiver sheet types in the paper catalog. In this case, upon the user selecting one receiver sheet type from the pull-down menu, the name of the selected receiver sheet type and a corresponding text box displaying the attributes of that type are then displayed by input/output device 25. This approach may be more convenient if the number of receiver sheet types is not too large.

It is preferred that the utility software for displaying the paper catalog, as executed by LCU 24, also include routines that permit the adding and deleting of additional receiver sheet types, editing or updating of the parameters associated with a receiver sheet type name, and the like.

According to the preferred embodiment of the invention, and as mentioned above, LCU 24 operates according to various computer programs, or sequences of computer-executable instructions. Many of these sequences are directed to the control and operation of printing machine 10, as evident from the foregoing description. In addition, typically printing machines 10 include one or more service applications, or service “applets”, within these computer programs or sequences executable by LCU 24. As known in the art, service applets include various programs by way of which operations related to monitoring, maintenance, and accounting functions are carried out by LCU 24. According to the preferred embodiment of the invention, one of these service applets executed by LCU 24 records a count of sheet feeds by type of receiver sheet, or paper type. As will be described in further detail below, this receiver sheet type count is preferably used to determine billing, maintenance schedules and contracts, and the like.

As shown in FIG. 1, according to this preferred embodiment of the invention, printing machine 10 also includes several additional meters, referred to as type meters 26. Type meters 26 may be conventional mechanical counting meters, but preferably are computer accessible counters (either hardware counters, or alternatively memory locations) that can be enabled, disabled, and read by LCU 24. As will be described in further detail below, each of additional meters 26 is associated with a specific receiver sheet type, and is incremented for each sheet of its associated type that is printed by printing machine 10. As in the case of main print meter 23, type meters 26 are preferably incremented by LCU 24 upon the feeding of a receiver sheet S of the corresponding type, at registration station 45, in the printing process carried out by printing machine 10. Type meters 26 are bidirectionally coupled to LCU 24, by way of which LCU 24 can access the stored counts.

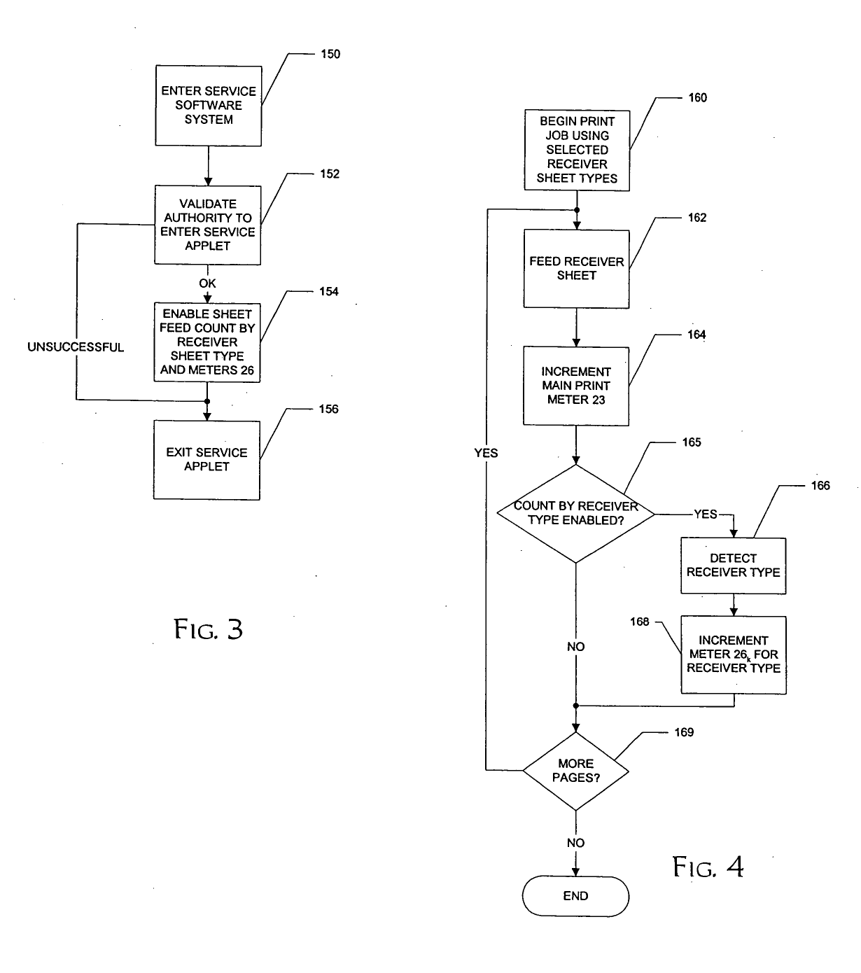

Referring now to FIG. 3, the operation of a service applet for maintaining and utilizing counts of sheet feeds by receiver sheet type, according to the preferred embodiment of the invention, will now be described. It is to be understood that this invention may be implemented according to various alternatives, including additional or different steps from those described herein and illustrated in FIG. 3, without departing from the true scope of the invention as claimed.

The service applet for maintaining and utilizing receiver sheet feed counts begins with process 160, in which a human user initiates a service software system of printing machine 10, as executed by LCU 24. In this example, process 160 is carried out by the human operator selecting various utility programs and applets via input/output device 25 of printing machine 10, or alternatively by addressing printing machine 10 over a computer network and initiating the service software system. It is contemplated that the service software system initiated in process 160 will typically include several maintenance functions for printing machine 10. Examples of such functions may include adjustment of certain parameters such as registration skew, image darkness or other image quality settings, and the like, as known in the art. According to this embodiment of the invention, this service software system also includes the enabling and disabling of sheet feed counts by receiver sheet type, as win be described below.

As will become apparent from the following description, it is contemplated that the print counts by receiver sheet type can be used in determining charges to the user of printing machine 10, either in the pricing of a maintenance contract, or in a per-sheet “click” charge for printing services. As such, some level of security is preferably provided, so that these charges are not fraudulently or inadvertently avoided. In process 152, therefore, LCU 24 executes an authentication of the user that is initiating the service applet. Authentication process 152 can be carried out in a number of conventional ways. For example, a field engineer may be authenticated by way of a physical key that is inserted into printing machine 10, such that the service applet is mechanically locked from alteration by the user. Alternatively, authentication process 152 may simply be a password protected software process for receiving entry of a user ID and password at input/output device 25 (or over the computer network) and comparing the password against a stored database of acceptable passwords and user IDs. Authentication process 152 may thus limit access to the service applet to field engineers; alternatively, service software authority may be granted to users or print customers, for example upon payment of an additional fee. It is contemplated that those skilled in the art having reference to this specification will readily envision the appropriate authority levels and access needs. If authentication process 152 is not successful (either after the first attempt, or after providing additional chances to the user to properly authenticate), the service applet simply terminates and is exited, in process 156.

Once authentication process 152 completes successfully, the field engineer or authorized user follows the appropriate menu-driven command to enable printing machine 10 to count sheet feeds not only of all receiver sheets (via main print counter 23), but also by counting sheet feeds by receiver sheet type (via type counters 26). It is contemplated that this enabling, carried out in process 154 of FIG. 3, may be effected by any one of a number of approaches. For example, a pull-down or other menu may display the paper catalog (as in FIG. 2), and provide a check-box by way of which the field engineer or authorized user indicates whether a separate sheet feed count (and corresponding meter 26) is to be enabled for that receiver sheet type. Alternatively, enable process 154 may be performed simply on a blanket basis, by assigning a separate counter 26 for each receiver sheet type available to printing machine 10. In any case, main print meter 23 continues to provide a global meter count of print sheet feeds, while meters 26 can be selectively enabled in process 154, either individually or collectively, to count sheet feeds or pages printed on each receiver sheet type. The service applet is then exited in process 156, and printing machine 10 is ready for use.

Referring now to FIG. 4, the operation of printing machine 10 in printing a print job according to the preferred embodiment of the invention will now be described. The print job begins, in process 160, with the receipt by printing machine 10 of the image and text information to be printed, in combination with other parameters concerning the print job, including instructions indicating the receiver sheet types to be used, and the association of various pages of the printed output that are to be printed on those receiver sheet types. This information may be specified by conventional workflow management software, such as that described in U.S. Patent Publication No. 2002/0131075 A1, commonly assigned herewith and incorporated herein by this reference and as implemented in the IMAGESMART DOCUMENT MASTERING software suite available from Heidelberg USA, Inc. Preferably, the selection of various receiver sheet types for the printed job is made by way of the paper catalog, an example of which is discussed above relative to FIG. 2.

The print job then begins with the conventional operation of printing machine 10. For purposes of this preferred embodiment of the invention, print counts are incremented upon the feeding of a receiver sheet at registration station 45. Of course, the print count may alternatively be based on other events in the print cycle. In this example, a receiver sheet is fed at registration station 45 in process 162, and main print meter 23 is incremented and the main count is advanced, in process 164. The advancing of main print meter 23 in process 164 may be accomplished mechanically, or by incrementing an electronic counter, implemented as a hardware circuit or in memory.

In decision 165, LCU 24 determines whether the service applet of FIG. 3 has enabled the function of counting sheet feeds by receiver sheet type. If not (decision 165 is NO), no additional counters or meters are advanced, and LCU 24 continues with decision 169 to determine whether additional pages remain to be printed. If so (decision 169 is YES), control passes back to process 162, in which the next receiver sheet is fed at registration station 45, and main print meter 23 is advanced in process 164. If no additional pages remain to be printed (decision 169 is NO), the print job terminates.

If LCU determines that the service applet has enabled the function of counting sheet feeds by receiver sheet type (decision 165 is YES), LCU 24 then executes process 166 to determine the receiver sheet type of the receiver sheet that was most recently fed in process 162. LCU 24 then advances the particular type meter 26ₖ associated with the receiver sheet type k identified in process 166. Control then passes to decision 169 to test whether the current print job is completed, and back to process 162 if additional pages remain to be printed.

In this manner, printing machine 10 maintains a meter count not only of the cumulative number of printed pages, in main print meter 23, but also maintains a count of each particular receiver sheet type that is printed, in type meters 26. The information stored in meters 23, 26 can provide a great deal of insight into the manner in which printing machine 10 is actually used. As mentioned above in connection with the Background of the Invention, wear of certain mechanical components within printing machine 10 can vary with receiver sheet type, as can the extent of contamination within printing machine 10, and also the rate at which certain consumables are used. As such, a particularly important utilization of the information stored in type meters 26 is the pricing of maintenance services for printing machine 10.

Of course, other uses of this information are also contemplated. For example, periodic maintenance intervals for printing machine 10 may vary according to the quantity and mix of the various receiver sheet types that it prints over time. Accordingly, the contents of main print meter 23 and type meters 26 may be used to determine a periodic maintenance schedule for printing machine 10. It is contemplated that these and other applications will be apparent to those skilled in the art having reference to this specification.

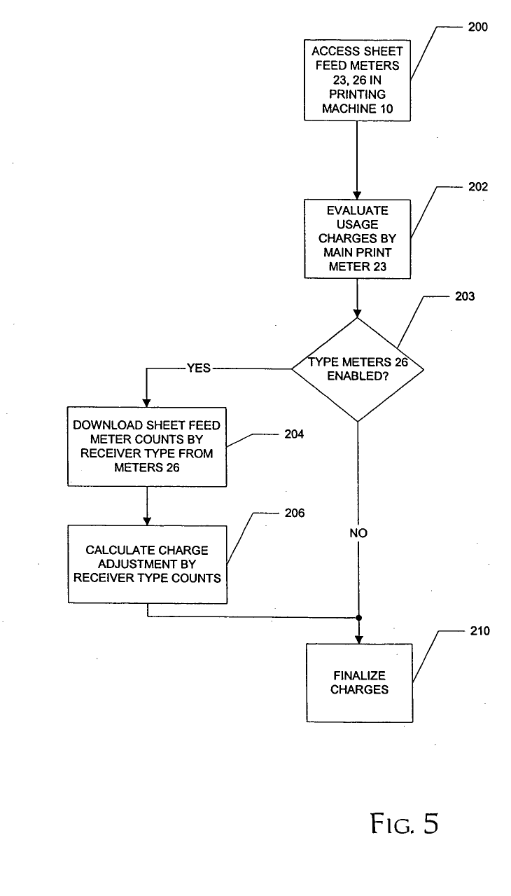

Referring now to FIG. 5, the operation of a service computer program that utilizes the receiver sheet type counts stored in meters 26 of printing machine 10, according to the preferred embodiment of the invention, will now be described in detail. The computer program illustrated in FIG. 5 may be executed at printing machine 10 itself, for example by LCU 24. Alternatively, the computer program may be executed by a separate computer system, such as a portable computer operated by a field engineer or service technician at the print shop, a computer or workstation located on the same computer network as printing machine 10, or a computer or workstation located remotely from printing machine 10 such as at a service organization location.

In process 200, main print meter 23 and type meters 26 are accessed, and their respective contents read. The manner in which process 200 is carried out will vary with the communications technology implemented and also with the location at which the computer program of FIG. 5 is being executed. One example of process 200 is the manual reading of meters 23, 26, and the communication of the stored counts to the service organization by telephone, handwritten document, or by download from a palmtop or portable computer used by the field engineer or service technician. Alternatively, if printing machine 10 is connected to a network, access process 200 can be carried out by electronic communication of the contents of meters 23, 26 over the network.

Process 202 is executed to evaluate the service or maintenance cost based on the overall print count stored in main print meter 23, as conventional in the art. It is contemplated that some charges may not depend on receiver sheet types; these charges may be determined in process 202 in that event, or as a default case if the receiver sheet type-specific counts were not enabled. In addition, it is contemplated that the overall print count may also be used in further calculations.

Decision 203 determines whether meters 26 in printing machine 10 for maintaining meter counts by receiver sheet type were enabled. If not (decision 203 is NO), the service and maintenance charges are finalized in process 210, in the conventional manner. On the other hand, if receiver sheet type counts were enabled (decision 203 is YES), the contents of type meters 26 in printing machine 10 are downloaded or otherwise accessed or retrieved in process 204. Once retrieved, these type meter 26 contents are used in process 206 to calculate adjustments to the service and maintenance charges based on the total print meter 23 count. For example, additional charges for cleaning excess contamination, or adding additional consumables, based on the mix of receiver sheet types actually used by printing machine 10, may be calculated in process 206. In addition to charges and costs, process 206 may adjust the periodic maintenance intervals for printing machine 10 generally, or for specific mechanical components such as certain rollers, if an excessive rate of certain high-wear receiver sheet types have been used. In any event, the adjustments calculated in process 206 are used in the finalizing of the customer charges, in process 210.

It is contemplated that those skilled in the art having reference to this specification will be readily able to derive various alternative implementations of this invention. For example, it is contemplated that specific receiver sheet types in the paper catalog that have similar wear and consumable behavior may be grouped, either in the service software programs or, if resources for on-board type meters 26 are limited, in the associating of type meters 26 to multiple receiver sheet types at printing machine 10. It is further contemplated, as mentioned above, that the counts of receiver sheet types actually printed may be used for a wide range of reliability and maintenance calculations.

While the present invention has been described according to its preferred embodiments, it is of course contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention as subsequently claimed herein.

1. A printing machine, comprising:
a photoconductor;
an exposure station, for effecting a charge pattern at a portion of the photoconductor, the charge pattern corresponding to an image to be printed;
a developer station, for electrostatically adhering toner to the photoconductor in a toner pattern corresponding to the charge pattern effected by the exposure station;
at least one paper source, for retaining a plurality of receiver sheets;
a transfer station, for transferring toner in the toner pattern from the photoconductor to a receiver sheet from the at least one paper source; and
a fuser station, comprising a fuser roller, for applying pressure to the receiver sheet so that the toner fuses to the receiver sheet in the toner pattern; and
a plurality of receiver sheet type counters, each associated with one of a plurality of receiver sheet types, each for counting a number of receiver sheets of its associated receiver sheet type that are printed by the printing machine.

2. The printing machine of claim 1, further comprising:
a main print meter, for counting a total number of receiver sheets of all receiver sheet types that are printed by the printing machine.

3. The printing machine of claim 1, further comprising:
a logic and control function, coupled to the plurality of receiver sheet type counters;
an input/output device, coupled to the logic and control function, for providing inputs to the logic and control function and for presenting output data received from the logic and control function.

4. The printing machine of claim 3, wherein inputs provided by the input/output device to the logic and control function comprise enabling the plurality of receiver sheet type counters to count the number of receiver sheets of its associated receiver sheet type that are printed by the printing machine.

5. The printing machine of claim 3, wherein the output data presented by the input/output device comprise contents of the plurality of receiver sheet type counters.

6. The printing machine of claim 3, wherein the input/output device comprises a network interface.

7. The printing machine of claim 3, wherein the input/output device comprises a display at the printing machine and a keypad for data entry.

8. The printing machine of claim 1, wherein the plurality of receiver sheet type counters comprise a plurality of counter circuits.

9. The printing machine of claim 1, wherein the plurality of receiver sheet type counters comprise addressable locations of a memory resource.

10. A method of operating a printing machine, comprising:
enabling each of a plurality of receiver sheet type counters to count a number of receiver sheets of an associated receiver sheet type that are printed by the printing machine;
selecting at least one receiver sheet type;
transferring an image to a receiver sheet of the selected type;
advancing the count of the receiver sheet type counter associated with the selected receiver sheet type of the receiver sheet to which an image is transferred in the transferring step; and
repeating the transferring and advancing step for a selected number of receiver sheets to be printed.

11. The method of claim 10, further comprising:
advancing the count of a main count meter for each receiver sheet of any of the plurality of receiver sheet types to which an image is transferred in the transferring step.

12. The method of claim 10, wherein the enabling step comprises:
initiating a service applet at the printing machine;
authenticating a user; and
enabling the plurality of receiver sheet type counters responsive to an input from the authenticated user.

13. The method of claim 10, wherein the selecting step comprises:
selecting at least one receiver sheet type from a paper catalog stored at the printing machine.

14. The method of claim 10, wherein the advancing step is performed responsive to a sheet feed of a receiver sheet of the selected receiver sheet type.

15. The method of claim 10, further comprising:
retrieving contents of each of the plurality of receiver sheet type counters; and
calculating a user charge using the retrieved contents.

16. The method of claim 10, further comprising:
retrieving contents of each of the plurality of receiver sheet type counters; and
calculating a maintenance interval using the retrieved contents.
